(19) United States
(12) Patent Application Publication
(10) Pub. No.: US 2002/0060444 A1
(43) Pub. Date: May 23, 2002

(54) Convertible car seat for infants

(76) Inventor: Denis Cote, Orford (CA)

Correspondence Address: Swabey Ogilvy Renault, Suite 1600, 1981 McGill College, Montreal, QC, H3A2Y3, CA

(21) Appl. No.: 09/550,109

(22) Filed: Apr. 14, 2000

(51) Int. Cl. B62B 1/00; B62B 5/00

(52) U.S. Cl. 280/648

(57) ABSTRACT

An infant restraint convertible between a safety car seat configuration and a cart-like infant carrier. The infant restraint comprises a seat shell, a handle mounted to the shell for movement between retracted and extended positions, and only one set of wheels mounted to the shell for movement as a single unit between an idle car seat position to a ground engaging position. The wheels are positioned so as to permit movement thereof between the idle car seat position and the ground engaging position while the seat shell still rests on a support surface. The handle cooperates with the wheels to allow rolling transportation of the infant restraint when the handle and the wheels are in their respective extended and ground engaging positions.

### BACKGROUND OF THE INVENTION

1. Field of the Invention

The present invention relates to child carriers and, more particularly, pertains to a convertible safety car seat for infants.

2. Description of the Prior Art

It is already known to have an infant safety car seat which is releasably securable to a base anchored on a vehicle seat in order to allow the infant to be carried in the safety car seat by a parent once the vehicle has arrived at destination. Such safety car seat generally includes a handle which is pivotable between an inclined position and an upright position for allowing the parent to lift the infant car seat from the base and then carry the infant car seat at his or her side. This procedure can be physically demanding as the parent has to normally carry with only one hand both the weight of the baby and the safety car seat.

With a view to overcoming the above drawback, it has been proposed to equip infant safety car seats with wheels for allowing the same to be used as strollers after transportation in a vehicle. For instance, U.S. Pat. No. 4,685,688 issued on Aug. 11, 1987 to Edwards discloses a combined child safety car seat and stroller comprising four wheels which can be independently displaced between a car seat position in which the wheels are recessed in the base of the device and an extended ground engaging position. When it is desired to convert the device from a safety car seat configuration to a stroller configuration, one has to lift the device so as to have access to the wheels and then successively extend the wheels to their ground engaging position. This requires a number of operations and can be done with difficulty while the child is still in the safety car seat.

U.S. Pat. No. 4,874,182 issued on Oct. 17, 1989 to Clark discloses a stroller apparatus for juvenile car seat including a base defining a bottom recess in the undersurface thereof for accommodating front and rear wheel units and a mechanism for actuating the wheels between an extended stroller position and a retracted inoperative car sear position. Before the apparatus can be converted from a car seat configuration to a stroller configuration, one has to first remove the apparatus from the seat of the vehicle in which it is installed and then operate the mechanism to extend the front and rear wheels to their ground engaging position.

Although the safety car seats disclosed in the above mentioned patents are convertible, it has been found that there is a need for a new lightweight infant restraint which can be readily and conveniently converted from a car seat to a cart or, alternatively, into a child carrier which can be carried by hand, and all, without having to remove the infant from the infant restraint.

### SUMMARY OF THE INVENTION

It is therefore an aim of the present invention to provide an infant car seat which can be conveniently converted into a cart-like infant carrier while still resting on a support surface with the infant therein.

It is also an aim of the present invention to provide such an infant car seat which is of relatively lightweight construction.

It is a further aim of the present invention to provide a convertible safety car seat which is relatively simple and economical to manufacture.

Therefore, in accordance with the present invention, there is provided a convertible safety car seat for infants, comprising a shell adapted to accommodate and restrain an infant. The shell has a base portion adapted to be releasably secured on a vehicle seat. A handle assembly is mounted to the shell for movement between retracted and extended positions. A set of wheels is connected to the shell for movement as a single unit from an idle car seat position to a ground engaging position, wherein the set of wheels is positioned so as to permit movement thereof between the idle car seat position and the ground engaging position while the base portion still rests on a support surface. The handle assembly cooperates with the wheels to allow rolling transportation of the convertible safety car seat when the handle assembly and the wheels are respectively in their extended and ground engaging positions.

In accordance with a further general aspect of the present invention, there is provided a convertible safety car seat for infants, comprising a shell adapted to accommodate and restrain an infant, the shell having a base portion adapted to be releasably secured on a vehicle seat, a handle assembly mounted to the shell for movement between retracted and extended positions, and a set of wheels connected to said shell. The set of wheels is movable as a single unit from an idle car seat position to a ground engaging position. Each wheel of the set of wheels is mounted at a distal end portion of a leg having a proximal portion structurally connected to the shell. The legs are interconnected by a cross member extending therebetween for conjoint movement therewith relative to the shell. The handle assembly cooperates with the wheels to allow rolling transportation of the convertible safety car seat when the handle assembly and the wheels are respectively in their extended and ground engaging positions.

### BRIEF DESCRIPTION OF THE DRAWINGS

Having thus generally described the nature of the invention, reference will now be made to the accompanying drawings, showing by way of illustration a preferred embodiment thereof, and in which:

FIG. 1 is a perspective view of a convertible infant restraint illustrated when used as a rear facing car seat in accordance with a first embodiment of the present invention;

FIG. 2 is a perspective view of the convertible infant restraint of FIG. 1 shown when used as a cart-like infant carrier;

FIG. 3 is a side elevational view of the convertible infant restraint of FIG. 1, illustrating the operation of the set of wheels and the handle assembly thereof;

FIG. 4 is a perspective view of a convertible infant restraint illustrated when used as a cart-like infant carrier in accordance with a second embodiment of the present invention.

FIG. 5 is a side elevational view of the convertible infant restraint of FIG. 4, illustrating the operation of the set of wheels and the handle assembly thereof.

### DESCRIPTION OF THE PREFERRED EMBODIMENTS

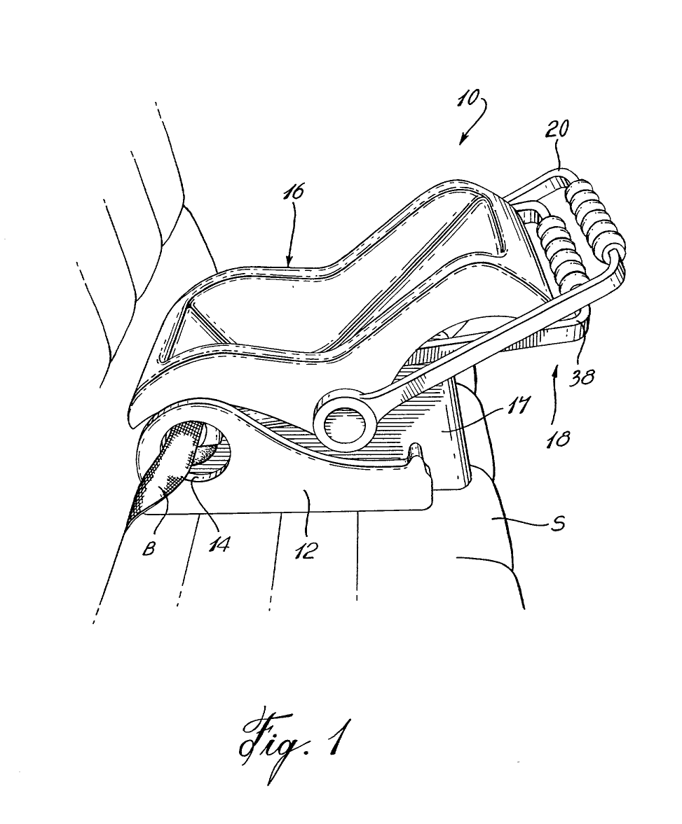

Now referring to the drawings, and in particular to FIGS. 1 to 3, an infant restraint 10 which is readily convertible from a rear facing safety car seat configuration to a cart-like infant carrier configuration will be described.

More specifically, as seen in FIG. 1, the infant restraint 10 is of the type adapted to be removably secured onto a base 12 anchored to a vehicle seat S. The infant restraint 10 can be secured to the base 12 by lowering the infant restraint 10 into the base 12 until it firmly snaps into place, as is well known in the art. The base 12 is secured to the vehicle seat S by routing a vehicle seat belt B through openings 14 defined on the sides of the base 12. Alternatively, the infant restraint 10 could be installed in the vehicle without the base 12 by directly anchoring the infant restraint 10 onto the vehicle seat S with the seat belt B, as is well known in the art.

The infant restraint 10 generally comprises a molded plastic seat shell 16 which is typically lined with a comfortable cloth padding (not shown) The seat shell 16 includes a base portion 17 having a substantially flat undersurface 19 adapted to be releasably interlocked with the base 12. Buckles and belts (not shown) are also provided to further restrain an infant in the seat shell 16.

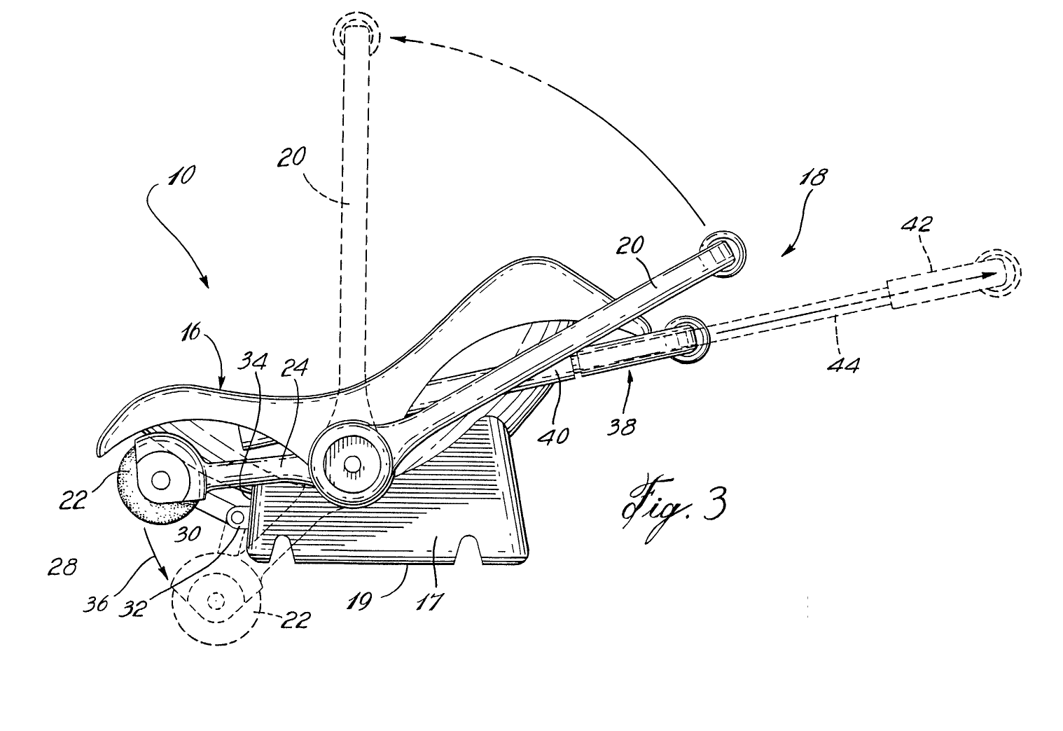

The infant restraint 10 also comprises a handle assembly 18 including a conventional inverted U-shaped carrying handle 20. As seen in FIG. 3, the carrying handle 20 is pivotable between an upright position (shown in dotted lines) for lifting the seat shell 16 from the base 12 and thereafter carrying the seat shell 16, and a lowered inclined car seat position wherein the handle 20 extends behind the seat shell 16, thereby allowing an infant to be installed in or lifted up from the seat shell 16. Conventional locking mechanisms (not shown) are provided for releasably locking the carrying handle 20 in either one of the upright and lowered inclined positions thereof.

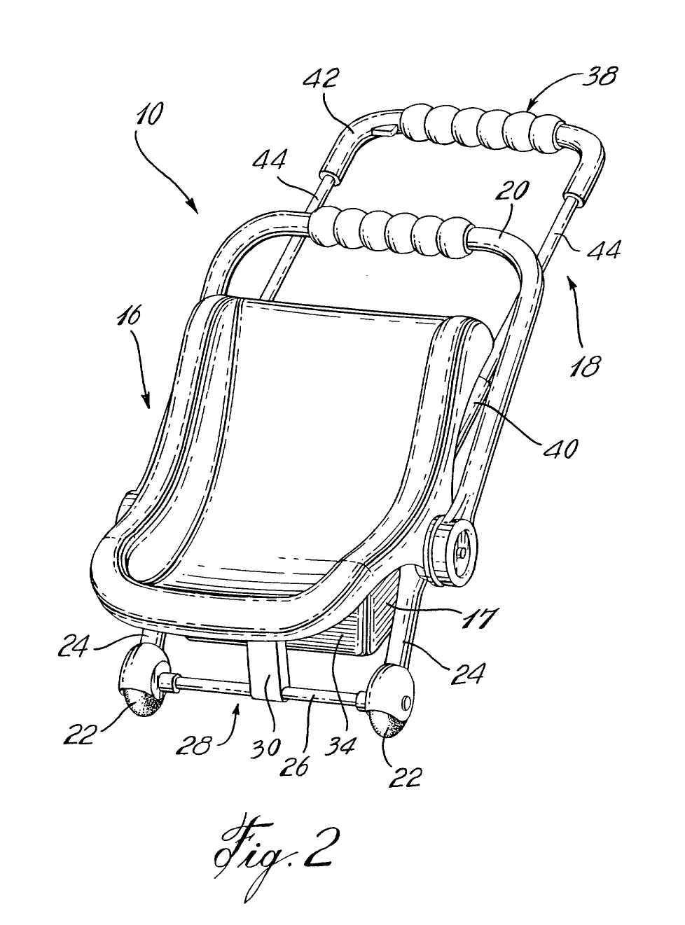

As seen in FIG. 2, the infant restraint 10 is provided with only one pair of front wheels 22. The front wheels 22 are jointly pivotable as a single unit between an idle car seat position (see FIG. 3 in full line) and a ground engaging position (see FIG. 3 in dotted lines). More particularly, each wheel 22 is mounted at the distal end of a leg 24 having a proximal end pivotally connected to one side of the seat shell 16. A cross member 26 (see FIG. 2) extends between the wheels 22 to structurally unify the legs 24 and, thus, ensure conjoint movement thereof relative to the seat shell 16. This advantageously allows the operator to simultaneously displace the wheels 22 between the car seat position and the ground engaging position thereof in a single operation.

Free pivot of the legs 24 relative to the seat shell 16 is prevented by a resisting mechanism 28 which is adapted to exert a force on the legs 24, which force must be overcome in order to pivot the legs 24 between the car seat position and the ground engaging position. As will be seen, the resisting mechanism 28 takes advantage of the resiliency of the plastic material forming the seat shell 16. More specifically, the resisting mechanism 28 includes a rigid link 30 having a first end pivotally mounted to the cross-member 26 substantially at mid-way between the opposed ends thereof and a second end pivotally mounted to a bracket 32 provided on the front wall 34 of the base portion 17. Since the wheels 22 are constrained to move along an arc of circle having for center the pivot axis of the legs 24 and since the point of pivot of the link 30 with respect to the seat shell 16 is off-center relative to the pivot axis of the legs 24, the link 30 will push on the front wall 34 of the base portion 17 at some point during the pivotal movement of the legs 24 between the idle car seat position and the ground engaging position, thereby inducing an elastic deformation in the front wall 34, which deformation will allow the legs 24 to be pivoted past that particular point, which can be viewed as a dead point. Accordingly, the front wall 34 resistance to deformation must be overcome to pivot the legs 24 past the above mentioned dead point.

The resisting mechanism 28 is advantageous in that it allows to automatically maintain the wheel 22 in either one of the idle car seat and ground engaging positions thereof, thereby keeping the number of manipulations required to convert the infant restraint 10 from a safety car seat to a cart-like infant carrier and vice versa to a minimum.

As seen in FIG. 3, the wheels 22 are located in front of the wall 34 and above the undersurface 19 of the base portion 17 when assuming their idle car seat position. This advantageously allows the wheels 22 to be pivoted from the idle car seat position to the ground engaging position as indicated by arrow 36 while the seat shell 16 is still resting on the base 12. This constitutes a significant advantage over known convertible safety seat car which have to be lifted while deploying the wheels.

As best seen in FIGS. 2 and 3, the handle assembly 18 further includes a telescopic handle 38 including a pair of elongated support tubes 40 fixedly mounted on opposed sides of the seat shell 16, and a U-shaped frame 42 having side members 44 telescopically received in the tubes 40. The side members 44 may be locked in position with respect to the support tubes 40 by any appropriate means, such as conventional spring loaded buttons.

As seen in FIG. 3, the telescopic handle 38 is displaceable between an idle retracted position and an extended position for allowing the infant restraint 10 to be used as a cart-like infant carrier when the wheels 22 are pivoted to their ground engaging position. Accordingly, the infant restraint 10 can be readily converted from a safety car seat to a cart-like infant carrier and vice versa in only two steps.

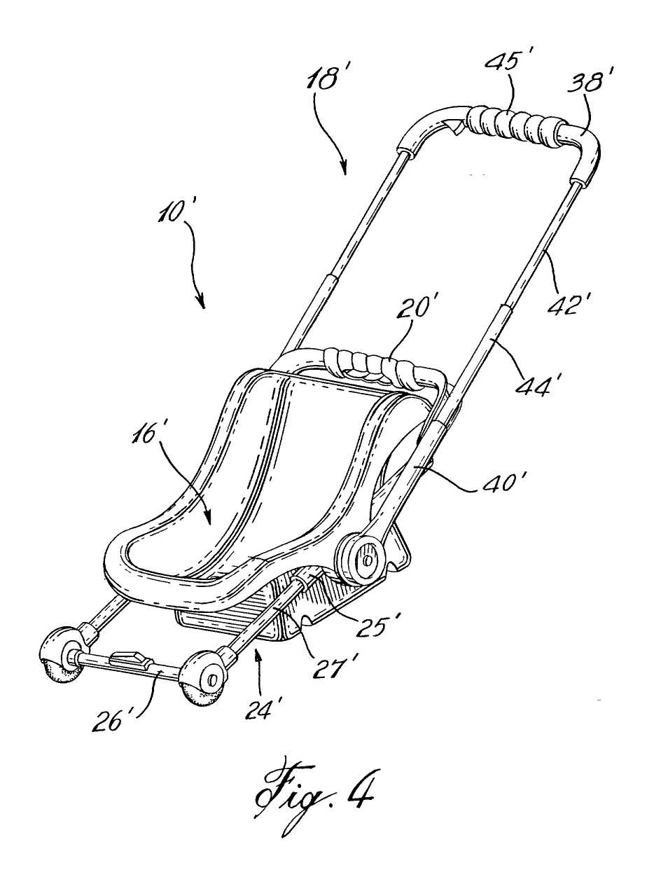

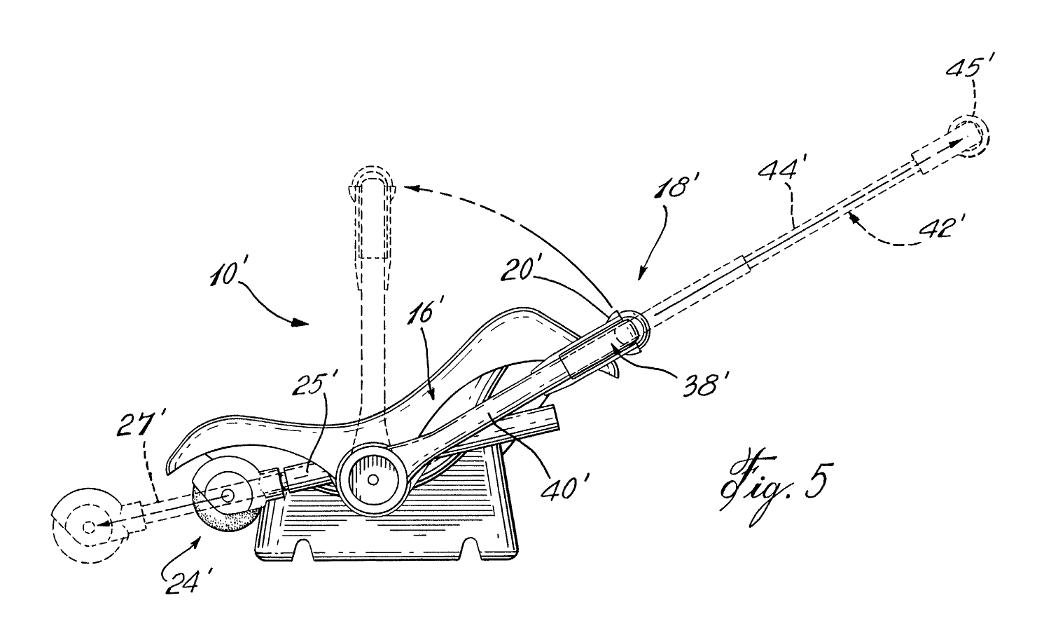

FIGS. 4 and 5 illustrate an infant restraint 10′ in accordance with a second embodiment of the present invention. The infant restraint 10′ essentially differs from the one described hereinbefore in that it includes a pair of telescopic legs 24′ rather than a pair of pivotable legs. The legs 24′ includes a pair of support tubes 25′ and a pair of extension tubes 27′ telescopically received in the support tubes 25′. Appropriate locking means, such as spring loaded buttons, are provided to releasably lock the extension tubes 27′ to the support tubes 25′.

The extension tubes 27′ are structurally interconnected by a cross member 261 (see FIG. 4). This ensures joint movement of the extension tubes 27′ between the idle car seat position (shown in full line in FIG. 5) and the ground engaging position (shown in dotted lines in FIG. 5).

The infant restraint 10′ further comprises a handle assembly 18′ which differs from the first described handle assembly 18 in that it includes a telescopic handle 38′ which is pivotally displaceable with a carrying handle 20′. The telescopic handle 38′ includes a pair of support tubes 40′ which are pivotally mounted to opposed sides of the seat shell 16′ for pivotal movement between a rearwardly inclined position (illustrated in full lines in FIG. 5) and an upright position (illustrated in dotted lines in FIG. 5). The telescopic handle 38′ further includes a U-shaped frame 42′ having a pair of elongated side members 44′ telescopically received in the support tubes 40′. The side members 44′ are connected together at an upper end thereof by a cross handle member 45′. The handle member 45′ is adapted, when displaced to a retracted position, to be received in a complementary fashion within the carrying handle 20′, which extends transversally between respective distal ends of the support tubes 40′.

When using the infant restraint 10′ as a safety car seat, the support tubes 40′ are displaced to their rearwardly inclined position with the side members 44′ retracted therein. To use the infant restraint 10′ as a cart-like infant carrier, one has simply to extend the legs 24′ and the telescopic handle 38′ with the latter assuming its rearwardly inclined position. Finally, if it is desired to transport the infant restraint 10′ by hand, one has only to pivot the telescopic handle 38′ to its upright position with the side members 44′ retracted within the support tubes 40′.

It is understood that the present invention is not limited to the above described combinations of pivotable or extendable wheels and pivotable and extendable handles. Indeed, any other combinations of pivotable/extendable wheels and pivotable/extendable handles could be used as well.

1. A convertible safety car seat for infants, comprising a shell adapted to accommodate and restrain an infant, said shell having a base portion adapted to be releasably secured on a vehicle seat, a handle assembly mounted to said shell for movement between retracted and extended positions, a set of wheels connected to said shell, said set of wheels being movable as a single unit from an idle car seat position to a ground engaging position, wherein said set of wheels is positioned so as to permit movement thereof between said idle car seat position and said ground engaging position while said base portion still rests on a support surface, and wherein said handle assembly cooperates with said set of wheels to allow rolling transportation of said convertible safety car seat when said handle assembly and said set of wheels are respectively in said extended and ground engaging positions thereof.

2. A convertible safety car seat as defined in claim 1, wherein each wheel of said set of wheels is mounted at a distal end portion of a leg having a proximal portion structurally connected to said shell, said legs being structurally linked by a cross member extending therebetween for conjoint movement therewith relative to said shell.

3. A convertible safety car seat as defined in claim 1, wherein each wheel of said set of wheels is mounted at a distal end portion of a leg having a proximal portion structurally connected to a side of said shell, said set of wheels being disposed in front of said base portion and above and undersurface thereof when assuming said idle car seat position.

4. A convertible safety car seat as defined in claim 2, wherein said legs are jointly pivotable with said cross member between said idle car seat position and said ground engaging position.

5. A convertible safety car seat as defined in claim 2, wherein each said leg includes a first leg segment fixed to said shell and a second leg segment telescopically related to said first leg segment, and wherein respective second leg segments of said legs are rigidly connected to each other by said cross member for conjoint sliding movement between fixed positions relative to said first leg segments.

6. A convertible safety car seat as defined in claim 4, wherein a resisting mechanism is provided to prevent free pivot of said legs, said resisting mechanism exerting a force on said legs, which force must be overcome to pivot said legs from said idle car seat position to said ground engaging position and vice versa.

7. A convertible safety car seat as defined in claim 6, wherein said legs include two legs which are pivotally mounted on opposed sides of said shell and which extend in a generally forward direction with respect thereto.

8. A convertible safety car seat as defined in claim 7, wherein said resisting mechanism includes a link pivotally mounted at a first end thereof to said shell and at a second end thereof to said cross member, said first end being off-center relative to a pivot axis of said legs so as to induce an elastic deformation in said shell at one point during the pivotal movement of said legs between said idle car seat position and said ground engaging position.

9. A convertible safety car seat as defined in claim 1, wherein said handle assembly is pivotable between an inclined position from which said handle assembly can be displaced to said extended position thereof to allow said convertible safety car seat to be used as a cart-like infant carrier and an upright position for allowing said convertible safety car seat to be lifted and carried by said handle assembly when the same is telescoped to said retracted position thereof.

10. A convertible safety car seat as defined in claim 9, wherein said handle assembly includes a pair of tubular arms pivotally mounted on opposed sides of said shell, a U-shaped handle having a pair of side members telescopically received in said tubular arms, and a carrying handle extending transversally between said tubular arms.

11. A convertible safety car seat for infants, comprising a shell adapted to accommodate and restrain an infant, said shell having a base portion capable of being releasably secured on a vehicle seat, a handle assembly mounted to said shell for movement between retracted and extended positions, a set of wheels connected to said shell, said set of wheels being movable as a single unit from an idle car seat position to a ground engaging position, wherein each wheel of said set of wheels is mounted at a distal end portion of a leg having a proximal portion structurally connected to said shell, said legs being interconnected by a cross member extending therebetween for conjoint movement therewith relative to said shell, and wherein said handle assembly cooperates with said set of wheels to allow rolling transportation of said convertible safety car seat when said handle assembly and said set of wheels are respectively in said extended and ground engaging positions thereof.

12. A convertible safety car seat for infants as defined in claim 11, wherein said set of wheels is positioned so as to permit movement thereof between said idle car seat position and said ground engaging position while said base portion still rests on a support surface.

13. A convertible safety car seat as defined in claim 12, wherein said set of wheels are disposed in front of said base portion and above and undersurface thereof when assuming said idle car seat position thereof.

14. A convertible safety car seat as defined in claim 11, wherein each said leg includes a first leg segment fixed to said shell and a second leg segment telescopically related to said first leg segment, and wherein respective second leg segments of said legs are rigidly connected to each other by said cross member for conjoint sliding movement between fixed positions relative to said first leg segments.

15. A convertible safety car seat as defined in claim 11, wherein said legs are jointly pivotable with said cross member between said idle car seat position and said ground engaging position.

16. A convertible safety car seat as defined in claim 15, wherein a resisting member is provided to prevent free pivot of said legs, said resisting member exerting a force on said legs, which force must be overcome to pivot said legs from said idle car seat position to said ground engaging position and vice versa.

17. A convertible safety car seat as defined in claim 16, wherein said legs include two legs which are pivotally mounted on opposed sides of said shell and which extend in a generally forward direction with respect thereto.

18. A convertible safety car seat as defined in claim 17, wherein said resisting member includes a link pivotally mounted at a first end thereof to said shell and at a second end thereof to said cross member, said first end being off-center relative to a pivot axis of said legs so as to induce an elastic deformation in said shell at one point during the pivotal movement of said legs between said idle car seat position and said ground engaging position.

19. A convertible safety car seat as defined in claim 11, wherein said handle assembly is pivotable between an inclined position from which said handle assembly can be displaced to said extended position thereof to allow said convertible safety car seat to be used as a cart-like infant carrier and an upright position for allowing said convertible safety car seat to be lifted and carried by said handle assembly when the same is telescoped to said retracted position thereof.

20. A convertible safety car seat as defined in claim 9, wherein said handle assembly includes a pair of tubular arms pivotally mounted on opposed sides of said shell, a U-shaped handle having a pair of side members telescopically received in said tubular arms, and a carrying handle extending transversally between said tubular arms.
